(19) United States
(12) Patent Application Publication
(10) Pub. No.: US 2014/0157305 A1
(43) Pub. Date: Jun. 5, 2014

(54) Advertisement Distribution in a Subscriber Network

(71) Applicant: GENERAL INSTRUMENT CORPORATION, Horsham, PA (US)

(72) Inventors: Christopher S. Del Sordo, Souderton, PA (US); Jiong Li, Singapore (SG); Lei Cao, New Haven, CT (US); Ranjeet Kumar, Singapore (SG); Kok Meng Wong, Singapore (SG)

(73) Assignee: GENERAL INSTRUMENT CORPORATION, Horsham, PA (US)

(21) Appl. No.: 13/691,174

(22) Filed: Nov. 30, 2012

(51) Int. Cl. H04N 21/81

(52) U.S. Cl. CPC H04N 21/812
USPC 725/34

(57) ABSTRACT

A computing device for providing Advertisement Decision Management services to a subscriber network that connects display devices. The computing device acquires a network program media stream associated with a network service from a provider network, delivers the network program media stream to a display device connected to the subscriber network, and collects usage data for the display device. When the computing device detects an advertising opportunity in the network program media stream, it selects an advertisement to fulfill the advertising opportunity, delivers the advertisement to the display device at the start time of the advertising opportunity, and delivers the network program media stream to the display device at the end time of the advertising opportunity. To select the advertisement, the computing device either requests the advertising opportunity from an advertisement server, or retrieves the advertisement from local data storage.

### BACKGROUND

A multiple system operator (MSO) delivers television programs, multimedia services, and advertisements to its subscribers. A current focus for the MSO is targeted advertising, the presentation of an advertisement to members of a targeted audience who are more likely to buy the advertised product. The MSO uses a targeted advertisement decision service (ADS) to select the targeted advertisements based on personal demographic and psychographic data associated with the subscriber. Today, the targeted ADS needs to accommodate an increased number of computing devices that the subscriber connects to a network at the subscriber's premises. These computing devices include set top gateway devices, set top boxes, digital televisions, display devices, personal computers, mobile phones, smartphones, tablet computers, gaming consoles, and handheld devices.

### BRIEF DESCRIPTION OF THE DRAWINGS

FIG. 1 is a block diagram that illustrates one embodiment of the hardware components of an advertisement distribution system.

FIG. 2 is a block diagram that illustrates, in detail, one embodiment of the hardware components shown in FIG. 1.

FIG. 3 is a message flow diagram that illustrates one embodiment of a method for distributing advertisements in a subscriber network.

FIG. 4 is a message flow diagram that illustrates one embodiment of a method for distributing advertisements in a subscriber network.

FIG. 5 is a message flow diagram that illustrates one embodiment of a method for distributing advertisements in a subscriber network.

FIG. 6 is a message flow diagram that illustrates one embodiment of a method for distributing advertisements in a subscriber network.

FIG. 7 is a message flow diagram that illustrates one embodiment of a method for distributing advertisements in a subscriber network.

FIG. 8 is a message flow diagram that illustrates one embodiment of a method for distributing advertisements in a subscriber network.

### DETAILED DESCRIPTION

A targeted advertisement distribution system includes advertisement decision manager (ADM) software that communicates with advertisement decision service (ADS) software to determine the most appropriate advertisement for the members of the target audience. In some conventional solutions for targeted advertisement distribution systems, a multiple system operator (MSO) located the ADM software in the network or cloud, typically at the headend. As targeted advertisement distribution systems evolve, the MSO begins to transition the targeted advertisement distribution system to a client-based model. In this client-based model, some conventional solutions connected each computing device to the network at the subscriber's premises, necessitating that each computing device had access to ADM functionality. The benefit of a client-based target advertisement distribution system is that it makes it easier to gather subscriber/customer viewing statistics and characteristics specific to usage on that particular client device. This enhances the ability of the targeted advertisement distribution system to provide a more accurate selection of the advertisements that match personal demographic and psychographic data for use on each device and customized for each device connected to the network at the consumer's premises.

In some conventional solutions, a client-based targeted advertisement distribution system that connects multiple computing devices to the consumer premises network creates many challenges. Each computing device that connects to the consumer premises network needs access to ADM functionality. One alternative is to include an implementation of ADM software on each device that connects to the network. Since the ADM software is somewhat complex, this means that the execution time of the ADM software on each device, and between devices, may differ. In addition, the consumer experience may differ for the targeted advertisement feature because it is possible for a consumer to simultaneously view the same network program on two devices and experience a different targeted advertisement on each device within the same consumer premises network. In addition, if one device includes the ADM software and another device does not, then one device would show a targeted advertisement while the other device would be viewing the network advertisement. Furthermore, these conventional solutions for client-based targeted advertisement distribution systems would likely slow the use and rollout of the targeted advertisement feature because many device manufacturers would need to develop and integrate this feature. The complexity of the ADM software resides in its ability to control the selection of the targeted advertisement, and collection of impression reporting data that will drive the selection of the targeted advertisements. The inclusion of an implementation of ADM software on each device that connects to the network is a costly solution to the problem created by these conventional solutions for client-based advertising distribution systems. The consumer will also experience different targeted advertisement implementations that could cause confusion or frustration while viewing the same content on different devices. This could actually reduce the use and rollout of targeted advertisement features.

In one embodiment of the invention, a single implementation of the ADM software resides on a gateway set top box in a consumer premises network, and provides advertisements for multiple display screens in the consumer premises network, television as well as mobile devices. Each client device in the consumer premises network interfaces to the ADM software on the gateway set top box to implement the targeted advertisement features. Each client device in the consumer premises network uses a standard protocol interface to communicate to the ADM software on the gateway set top box. Thus, the ADM software on the gateway set top box controls all of the display rendering for all the targeted advertisements on all of the devices connected to the consumer premises network. Furthermore, the ADM software collects impression reporting data, subscriber/customer viewing statistics, or characteristics specific to consumer usage data, from the devices connected to the consumer premises network that will drive the selection of the targeted advertisements. In addition, the ADM software on the gateway set top box is compatible with the typical scenario where the consumer does not use a mobile device to control or view the content, but interfaces directly to the gateway set top box to select the content that the consumer will view on a digital television.

FIG. 1 is a block diagram that illustrates one embodiment of the hardware components of a client-based targeted advertising system. The headend 110 is a master facility that the MSO uses to receive television signals, and process the television signals into media streams for distribution to its subscribers. The headend 110 includes an advertisement server 112, and electronic programming guide (EPG)/video on demand (VOD) metadata server 114. The advertisement server 112 is a general-purpose server computer that stores advertisements that the headend 110 inserts into the media streams distributed to the subscribers.

A provider network 120 connects the headend 110 to a subscriber network 130. In one embodiment, the provider network 120 is a hybrid-fiber coaxial (HFC) broadband network that combines optical fiber and coaxial cable that the MSO uses to deliver television programming and network services to a subscriber's premises. The subscriber network 130 connects the subscriber device 140 to the provider network 120. In one embodiment, the subscriber network 130 is a local area network that combines wired and wireless technology to distribute the high-definition television programming and network services from the MSO to client devices throughout the subscriber's premises.

The subscriber device 140 shown in FIG. 1 is a computing device that includes an advertisement decision manager 142 to communicate with the advertisement server 112 located at the headend 110. In one embodiment, the subscriber device 140 is a computing device such as a gateway set top box, set top box, personal computer, entertainment device, or digital media server. The subscriber device 140 connects to client devices within the subscriber network 130. The client devices include a display device 144 (e.g., a digital television), set top box 146, personal computer, computer display, and a mobile device 150 (e.g., a mobile phone, smartphone, tablet computer, gaming console or handheld device). In one embodiment, the subscriber device 140 is a gateway device that streams media content to each client device that connects to the subscriber network 130. In another embodiment, each client device that connects to the subscriber network 130 includes a user interface to control browsing of an electronic programming guide (EPG) or video on demand (VOD) listing, selection of the streaming media content to view on the client device, and control of the playback of the streaming media content.

The embodiment shown in FIG. 1 is a client-based target advertisement system that includes a centralized advertisement decision manager 142 for the subscriber network 130, rather than including an instantiation of an advertisement decision manager residing on each client device in the subscriber network 130. The advertisement decision manager 142 provides advertisements for any display device 144, set top box 146, or mobile device 150 connected to the subscriber network 130 via either a wired connection or wireless connection. The advertisement decision manager 142 resides on the subscriber device 140 responsible for acquiring the media content stream from the headend 110 or internet (not shown), and distributing the media content stream throughout the subscriber network 130. The communication between each client device and the advertisement decision manager 142 uses a standard protocol interface. In another embodiment, the advertisement decision manager 142 also orchestrates the recording of targeted advertisements from the advertisement server 112 on the subscriber device 140 (e.g., the data storage device 230 or memory 250) or on a device connected to the subscriber device 140 (e.g., a database server). Once loaded, the advertisement decision manager 142 determines whether to insert the advertisements that are resident on the subscriber device 140 instead of the advertisements that it receives from the advertisement server 112.

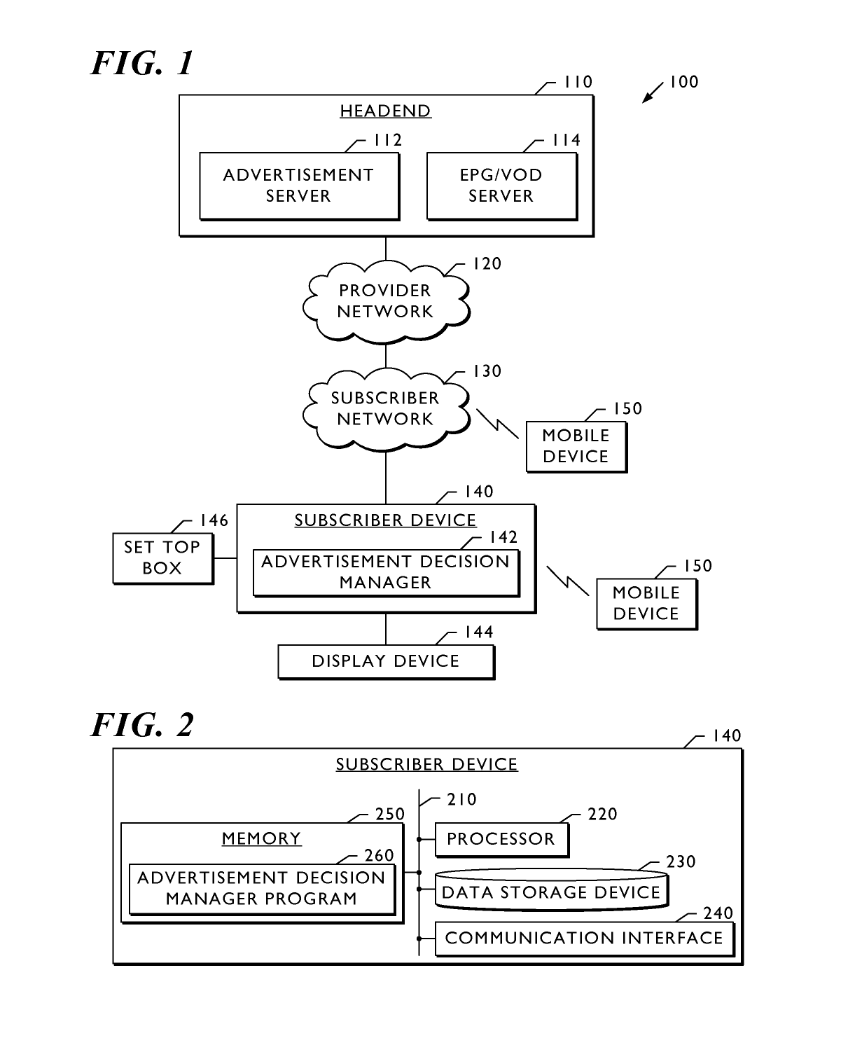

FIG. 2 is a block diagram that illustrates, in detail, one embodiment of the hardware components shown in FIG. 1. As shown in FIG. 2, the subscriber device 140 is a general-purpose computer. A bus 210 is a communication medium connecting a processor 220, data storage device 230 (such as a serial ATA (SATA) hard disk drive, optical drive, small computer system interface (SCSI) disk, flash memory, or the like), communication interface 240, and memory 250 (such as random access memory (RAM), dynamic RAM (DRAM), non-volatile computer memory, flash memory, or the like). The communication interface 240 allows for two-way communication of data and content between the subscriber device 140 and the subscriber network 130, display device 144, set top box 146, and mobile device 150.

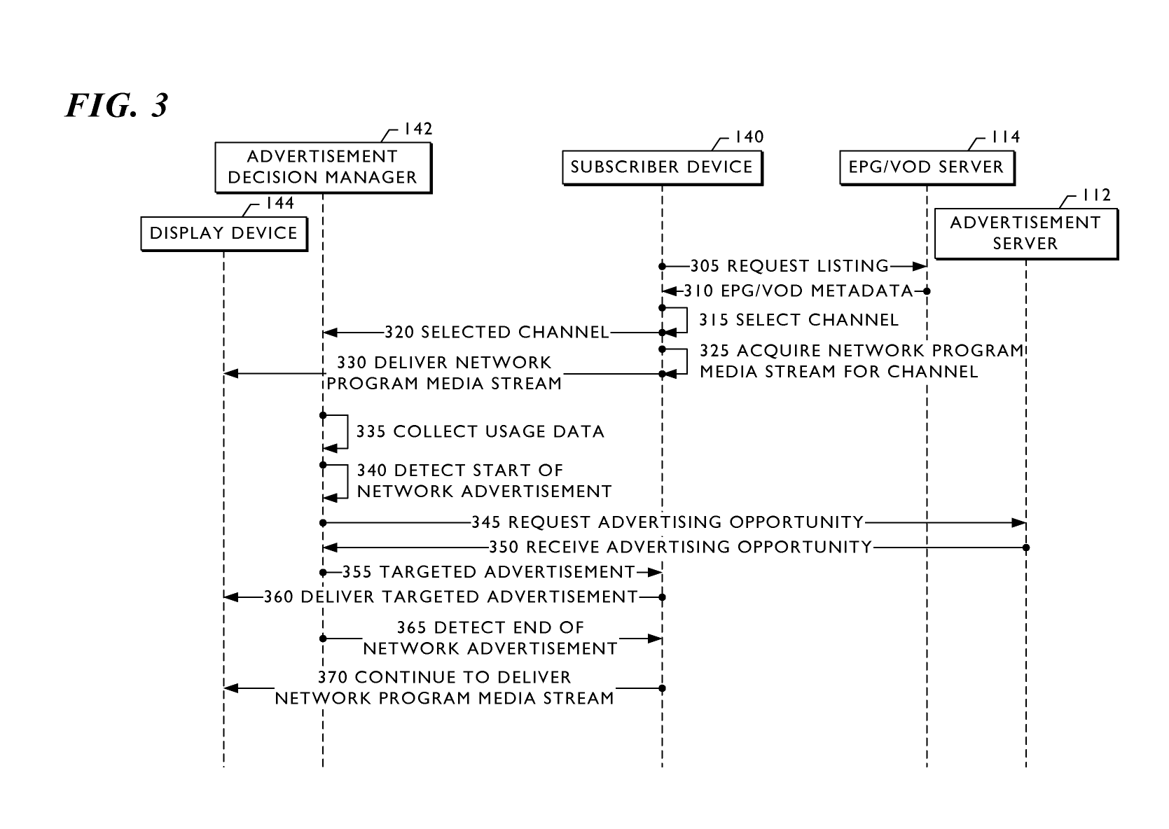

The processor 220 of the subscriber device 140 performs the disclosed methods by executing sequences of operational instructions that comprise each computer program resident in, or operative on, the memory 250. The reader should understand that the memory 250 may include operating system, administrative, and database programs that support the programs disclosed in this application. In one embodiment, the configuration of the memory 250 of the subscriber device 140 includes an advertisement decision manager program 260. The advertisement decision manager program 260 performs the method disclosed in the exemplary embodiments depicted in FIGS. 3, 4, 5, 6, 7, and 8. When the processor 220 performs the disclosed method, it stores intermediate results in the memory 250 or data storage device 230. In another embodiment, the processor 220 may swap these programs, or portions thereof, in and out of the memory 250 as needed, and thus may include fewer than all of these programs at any one time.

FIG. 3 is a message flow diagram that illustrates one embodiment of a method for distributing advertisements in a subscriber network. FIG. 3 depicts the message flow when a subscriber operates the subscriber device 140, either directly or via a remote control device, to select a channel from an EPG/VOD listing, and views the media content stream on a display device 144, such as a high-definition television, connected to the subscriber device 140.

The embodiment shown in FIG. 3, with reference to FIG. 1 and FIG. 2, illustrates an exemplary message flow between the subscriber device 140, display device 144, and headend 110. The subscriber device 140 initiates the message flow shown in FIG. 3 by sending a request for a listing to the EPG/VOD server 114 associated with the headend 110 (step 305). The EPG/VOD server responds to the request by sending EPG/VOD metadata to the subscriber device 140 (step 310). The subscriber device 140 selects one of the channels in the EPG/VOD listing (step 315), and sends the selected channel to the advertisement decision manager 142 (step 320). The subscriber device 140 acquires the network program media stream for the selected channel (step 325), and delivers the network program media stream to the display device 144 (step 330). The advertisement decision manager 142 collects usage data (step 335), and monitors the network program media stream. When the advertisement decision manager 142 detects the start of a network advertisement in the network program media stream (step 340), the advertisement decision manager 142 sends a request for an advertising opportunity (i.e., placement opportunity) to the advertisement server 112 associated with the headend 110 (step 345). The advertisement server 112 sends an advertising opportunity to the advertisement decision manager 142 in response (step 350). The advertisement decision manager 142 sends a targeted advertisement that fulfills the advertising opportunity to the subscriber device 140 (step 355). The subscriber device 140 delivers the targeted advertisement to the display device 144 connected to the subscriber device 140 (step 360). When the targeted advertisement finishes playing, the advertisement decision manager 142 detects the end of the network advertisement (step 365), and the subscriber device 140 continues to deliver the network program media stream to the display device 144 (step 370).

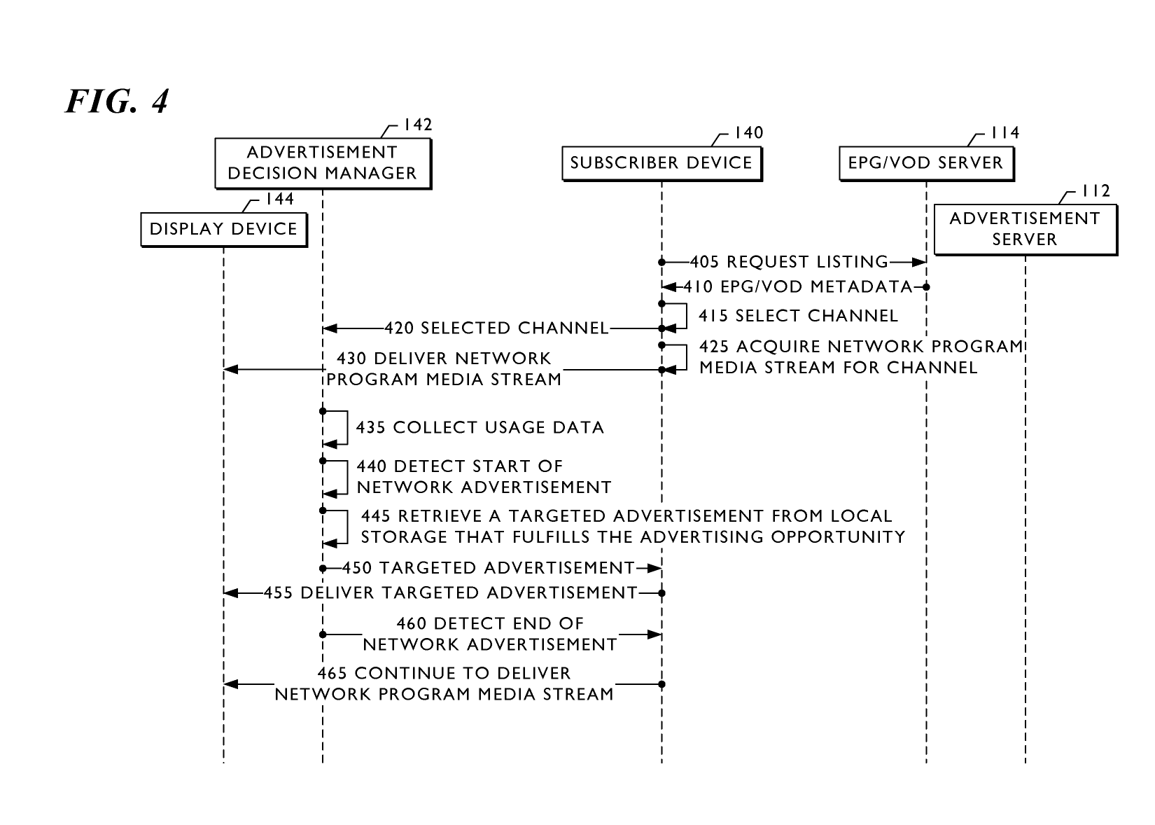

FIG. 4 is a message flow diagram that illustrates one embodiment of a method for distributing advertisements in a subscriber network. FIG. 4 depicts the message flow when a subscriber operates the subscriber device 140, either directly or via a remote control device, to select a channel from an EPG/VOD listing, and views the media content stream on a display device 144, such as a high-definition television, connected to the subscriber device 140.

The embodiment shown in FIG. 4, with reference to FIG. 1 and FIG. 2, illustrates an exemplary message flow between the subscriber device 140, display device 144, and headend 110. The subscriber device 140 initiates the message flow shown in FIG. 4 by sending a request for a listing to the EPG/VOD server 114 associated with the headend 110 (step 405). The EPG/VOD server responds to the request by sending EPG/VOD metadata to the subscriber device 140 (step 410). The subscriber device 140 selects one of the channels in the EPG/VOD listing (step 415), and sends the selected channel to the advertisement decision manager 142 (step 420). The subscriber device 140 acquires the network program media stream for the selected channel (step 425), and delivers the network program media stream to the display device 144 (step 430). The advertisement decision manager 142 collects usage data (step 435), and monitors the network program media stream. When the advertisement decision manager 142 detects the start of a network advertisement in the network program media stream (step 440), the advertisement decision manager 142 retrieves a targeted advertisement that fulfills the advertising opportunity from a data storage device connected to the subscriber device 140 (step 445). In one embodiment, the advertisement decision manager 142 stored the targeted advertisement in the data storage device from an advertising opportunity previously provided by the advertisement server 112. In another embodiment, the data storage device is pre-loaded with targeted advertisements provided by a network provider. The advertisement decision manager 142 sends a targeted advertisement that fulfills the advertising opportunity to the subscriber device 140 (step 450). The subscriber device 140 delivers the targeted advertisement to the display device 144 connected to the subscriber device 140 (step 455). When the targeted advertisement finishes playing, the advertisement decision manager 142 detects the end of the network advertisement (step 460), and the subscriber device 140 continues to deliver the network program media stream to the display device 144 (step 465).

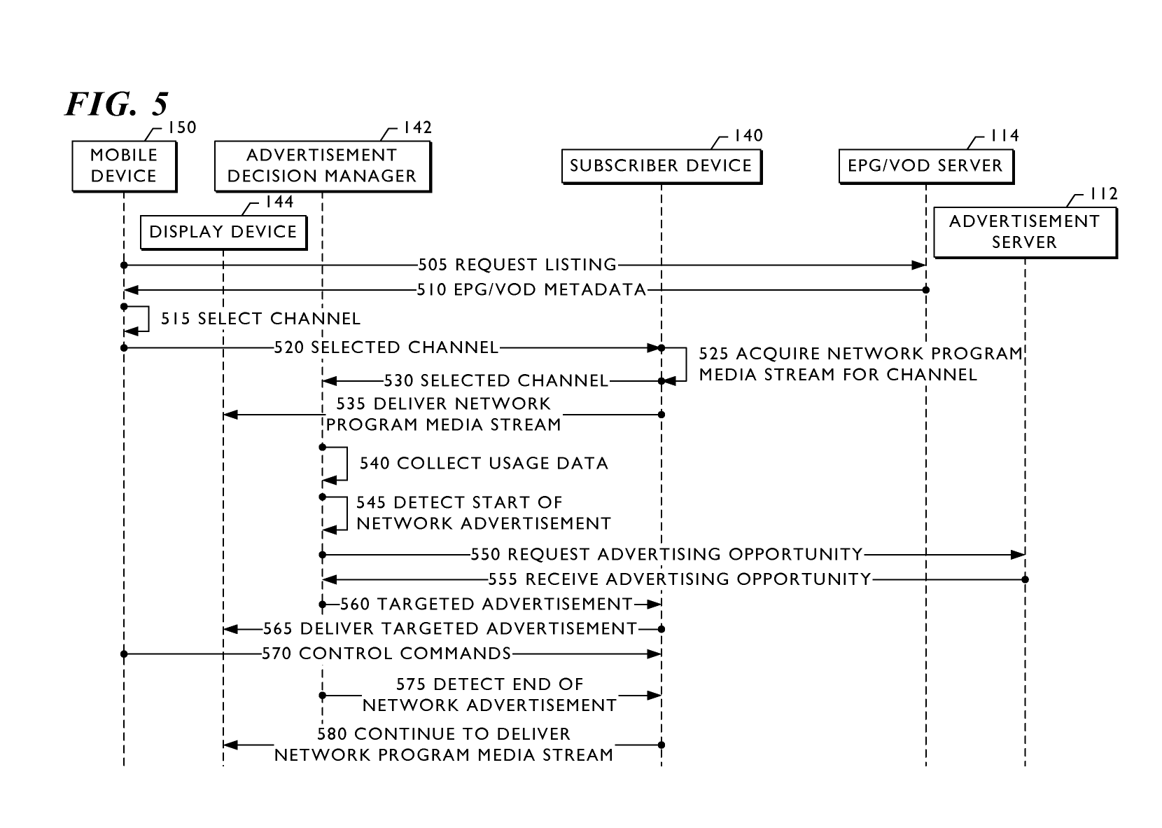

FIG. 5 is a message flow diagram that illustrates one embodiment of a method for distributing advertisements in a subscriber network. FIG. 5 depicts the message flow when a subscriber operates a mobile device 150 to select a channel from an EPG/VOD listing, and views the media content stream on a display device 144, such as a high-definition television, connected to the subscriber device 140.

The embodiment shown in FIG. 5, with reference to FIG. 1 and FIG. 2, illustrates an exemplary message flow between the subscriber device 140, mobile device 150, and headend 110. The mobile device 150 initiates the message flow shown in FIG. 5 by sending a request for a listing to the EPG/VOD server 114 associated with the headend 110 (step 505). The EPG/VOD server responds to the request by sending EPG/VOD metadata to the mobile device 150 (step 510). The mobile device 150 selects one of the channels in the EPG/VOD listing (step 515), and sends the selected channel to the subscriber device 140 (step 520). The subscriber device 140 acquires the network program media stream for the selected channel (step 525), sends the selected channel to the advertisement decision manager 142 (step 530), and delivers the network program media stream to the display device 144 (step 535). The advertisement decision manager 142 collects usage data (step 540), and monitors the network program media stream. When the advertisement decision manager 142 detects the start of a network advertisement in the network program media stream (step 545), the advertisement decision manager 142 sends a request for an advertising opportunity (i.e., placement opportunity) to the advertisement server 112 associated with the headend 110 (step 550). The advertisement server 112 sends an advertising opportunity to the advertisement decision manager 142 in response (step 555). The advertisement decision manager 142 sends the targeted advertisement that fulfills the advertising opportunity to the subscriber device 140 (step 560). The subscriber device 140 delivers the targeted advertisement to the display device 144 connected to the subscriber device 140 (step 565). The mobile device 150 periodically sends control commands to the subscriber device 140 (step 570) to control the playback of the targeted advertisement or network program media stream. In one embodiment, these control commands are video playback commands such as pause, fast-forward, rewind, skip, fast play, and slow play. In another embodiment, these control commands are audio playback commands. When the targeted advertisement finishes playing, the advertisement decision manager 142 detects the end of the network advertisement (step 575), and the subscriber device 140 continues to deliver the network program media stream to the display device 144 (step 580).

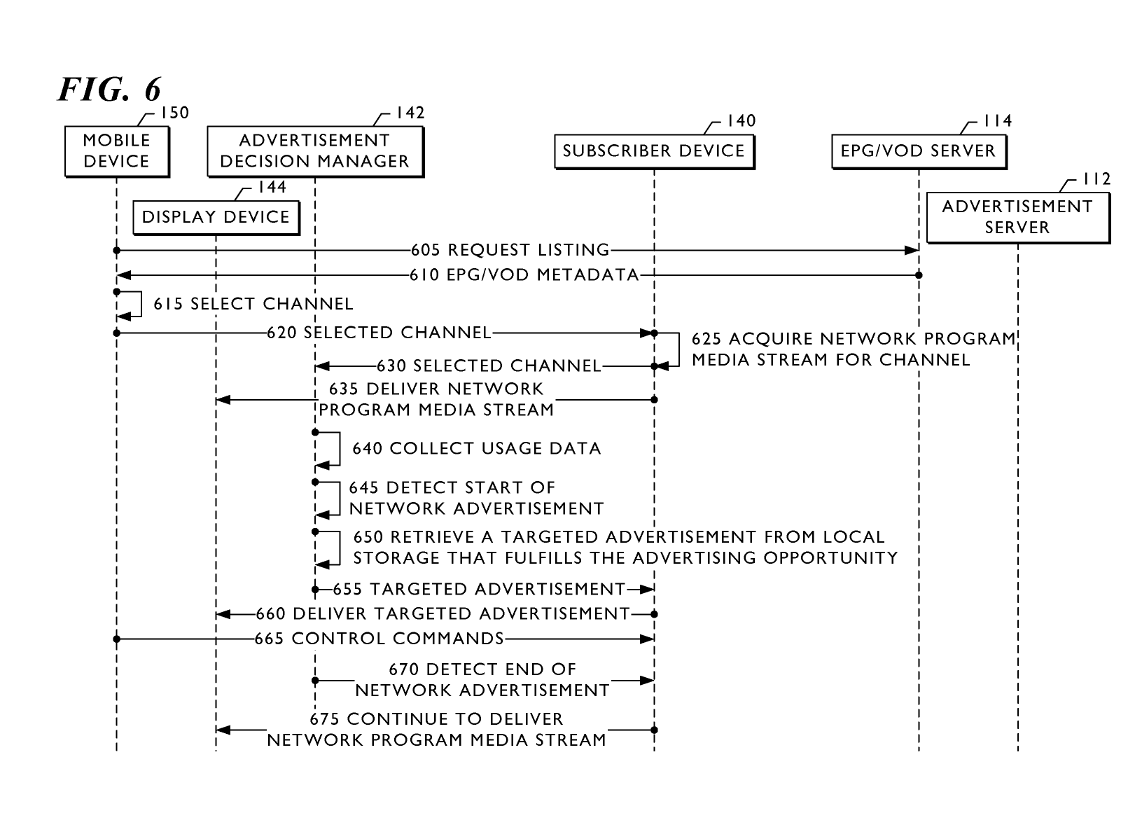

FIG. 6 is a message flow diagram that illustrates one embodiment of a method for distributing advertisements in a subscriber network. FIG. 6 depicts the message flow when a subscriber operates a mobile device 150 to select a channel from an EPG/VOD listing, and views the media content stream on a display device 144, such as a high-definition television, connected to the subscriber device 140.

The embodiment shown in FIG. 6, with reference to FIG. 1 and FIG. 2, illustrates an exemplary message flow between the subscriber device 140, mobile device 150, and headend 110. The mobile device 150 initiates the message flow shown in FIG. 4 by sending a request for a listing to the EPG/VOD server 114 associated with the headend 110 (step 605). The EPG/VOD server responds to the request by sending EPG/VOD metadata to the mobile device 150 (step 610). The mobile device 150 selects one of the channels in the EPG/VOD listing (step 615), and sends the selected channel to the subscriber device 140 (step 620). The subscriber device 140 acquires the network program media stream for the selected channel (step 625), sends the selected channel to the advertisement decision manager 142 (step 630), and delivers the network program media stream to the display device 144 (step 635). The advertisement decision manager 142 collects usage data (step 640), and monitors the network program media stream. When the advertisement decision manager 142 detects the start of a network advertisement in the network program media stream (step 645), the advertisement decision manager 142 retrieves a targeted advertisement from local storage (e.g., data storage device 230) that fulfills the advertising opportunity (step 650). In one embodiment, the advertisement decision manager 142 stored the targeted advertisement in the data storage device from an advertising opportunity previously provided by the advertisement server 112. In another embodiment, the data storage device is pre-loaded with targeted advertisements provided by a network provider. The advertisement decision manager 142 sends the targeted advertisement that fulfills the advertising opportunity to the subscriber device 140 (step 655). The subscriber device 140 delivers the targeted advertisement to the display device 144 connected to the subscriber device 140 (step 660). The mobile device 150 periodically sends control commands to the subscriber device 140 (step 665) to control the playback of the targeted advertisement or network program media stream. In one embodiment, these control commands are video playback commands such as pause, fast-forward, rewind, skip, fast play, and slow play. In another embodiment, these control commands are audio playback commands. When the targeted advertisement finishes playing, the advertisement decision manager 142 detects the end of the network advertisement (step 670), and the subscriber device 140 continues to deliver the network program media stream to the display device 144 (step 675).

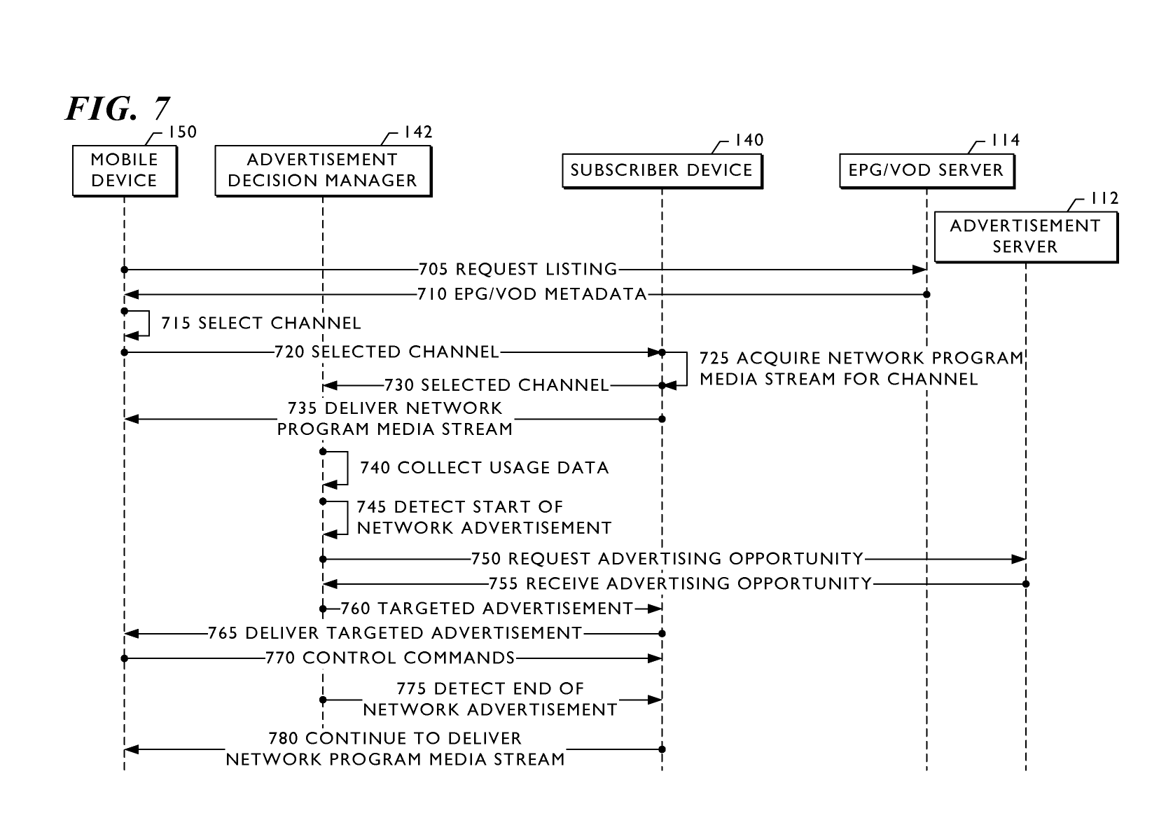

FIG. 7 is a message flow diagram that illustrates one embodiment of a method for distributing advertisements in a subscriber network. FIG. 7 depicts the message flow when a subscriber operates a mobile device 150 to select a channel from an EPG/VOD listing, and views the media content stream on the mobile device 150, such as a smartphone or tablet computer, connected to the subscriber network 130.

The embodiment shown in FIG. 7, with reference to FIG. 1 and FIG. 2, illustrates an exemplary message flow between the subscriber device 140, mobile device 150, and headend 110. The mobile device 150 initiates the message flow shown in FIG. 7 by sending a request for a listing to the EPG/VOD server 114 associated with the headend 110 (step 705). The EPG/VOD server responds to the request by sending EPG/VOD metadata to the mobile device 150 (step 710). The mobile device 150 selects one of the channels in the EPG/VOD listing (step 715), and sends the selected channel to the subscriber device 140 (step 720). The subscriber device 140 acquires the network program media stream for the selected channel (step 725), sends the selected channel to the advertisement decision manager 142 (step 730), and delivers the network program media stream to the mobile device 150 (step 735). The advertisement decision manager 142 collects usage data (step 740), and monitors the network program media stream. When the advertisement decision manager 142 detects the start of a network advertisement in the network program media stream (step 745), the advertisement decision manager 142 sends a request for an advertising opportunity to the advertisement server 112 associated with the headend 110 (step 750). The advertisement server 112 sends an advertising opportunity to the advertisement decision manager 142 in response (step 755). The advertisement decision manager 142 sends a targeted advertisement that fulfills the advertising opportunity to the subscriber device 140 (step 760). The subscriber device 140 delivers the targeted advertisement to the mobile device 150 (step 765). The mobile device 150 periodically sends control commands to the subscriber device 140 (step 770) to control the playback of the targeted advertisement or network program media stream. In one embodiment, these control commands are video playback commands such as pause, fast-forward, rewind, skip, fast play, and slow play. In another embodiment, these control commands are audio playback commands. When the targeted advertisement finishes playing, the advertisement decision manager 142 detects the end of the network advertisement (step 775), and the subscriber device 140 continues to deliver the network program media stream to the mobile device 150 (step 780).

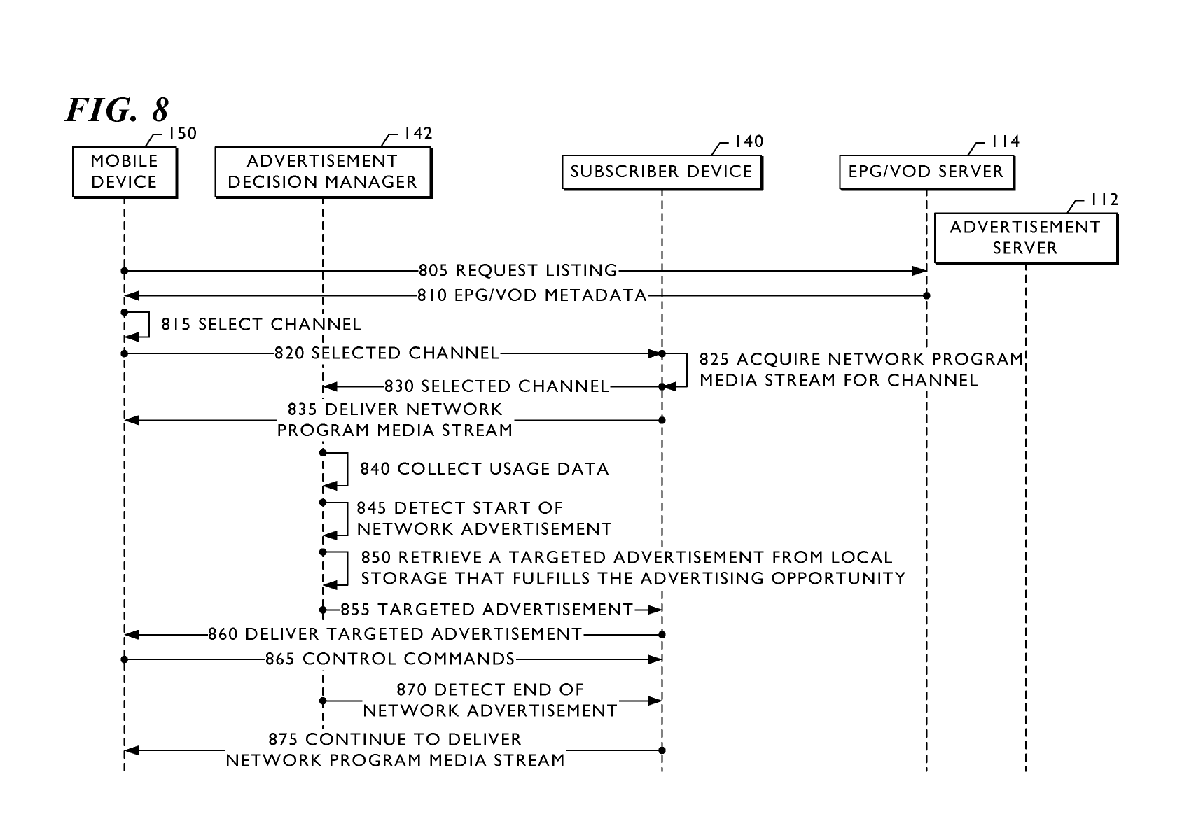

FIG. 8 is a message flow diagram that illustrates one embodiment of a method for distributing advertisements in a subscriber network. FIG. 8 depicts the message flow when a subscriber operates a mobile device 150 to select a channel from an EPG/VOD listing, and views the media content stream on the mobile device 150, such as a smartphone or tablet computer, connected to the subscriber network 130.

The embodiment shown in FIG. 8, with reference to FIG. 1 and FIG. 2, illustrates an exemplary message flow between the subscriber device 140, mobile device 150, and headend 110. The mobile device 150 initiates the message flow shown in FIG. 8 by sending a request for a listing to the EPG/VOD server 114 associated with the headend 110 (step 805). The EPG/VOD server responds to the request by sending EPG/VOD metadata to the mobile device 150 (step 810). The mobile device 150 selects one of the channels in the EPG/VOD listing (step 815), and sends the selected channel to the subscriber device 140 (step 820). The subscriber device 140 acquires the network program media stream for the selected channel (step 825), sends the selected channel to the advertisement decision manager 142 (step 830), and delivers the network program media stream to the mobile device 150 (step 835). The advertisement decision manager 142 collects usage data (step 840), and monitors the network program media stream. When the advertisement decision manager 142 detects the start of a network advertisement in the network program media stream (step 845), the advertisement decision manager 142 retrieves a targeted advertisement from local storage (e.g., data storage device 230) that fulfills the advertising opportunity (step 850). In one embodiment, the advertisement decision manager 142 stored the targeted advertisement in the data storage device from an advertising opportunity previously provided by the advertisement server 112. In another embodiment, the data storage device is pre-loaded with targeted advertisements provided by a network provider. The advertisement decision manager 142 sends a targeted advertisement that fulfills the advertising opportunity to the subscriber device 140 (step 855). The subscriber device 140 delivers the targeted advertisement to the mobile device 150 (step 860). The mobile device 150 periodically sends control commands to the subscriber device 140 (step 865) to control the playback of the targeted advertisement or network program media stream. In one embodiment, these control commands are video playback commands such as pause, fast-forward, rewind, skip, fast play, and slow play. In another embodiment, these control commands are audio playback commands. When the targeted advertisement finishes playing, the advertisement decision manager 142 detects the end of the network advertisement (step 870), and the subscriber device 140 continues to deliver the network program media stream to the mobile device 150 (step 875).

Although the disclosed embodiments describe a fully functioning computing device and method for distributing advertisements in a subscriber network, the reader should understand that other equivalent embodiments exist. Since numerous modifications and variations will occur to those reviewing this disclosure, the computing device and method for distributing advertisements in a subscriber network is not limited to the exact construction and operation illustrated and disclosed. Accordingly, this disclosure intends all suitable modifications and equivalents to fall within the scope of the claims.

1. A subscriber device for providing Advertisement Decision Management (ADM) services to a subscriber network that connects a plurality of display devices, comprising:
a communication interface to connect the subscriber device to the subscriber network and said plurality of display devices;
a memory device resident in the subscriber device; and
a processor disposed in communication with the communication interface and the memory device, the processor configured to:
acquire a network program media stream associated with a network service from a provider network;
deliver the network program media stream to said plurality of display devices;
collect usage data for said plurality of display devices;
detect an advertising opportunity in the network program media stream, the advertising opportunity having a start time and an end time;
select an advertisement to fulfill the advertising opportunity, where the selection of the advertisement is performed by the subscriber device based on the usage data;
deliver the advertisement to said plurality of display devices at the start time of the advertising opportunity; and
deliver the network program media stream to said plurality of display devices at the end time of the advertising opportunity.

2. The subscriber device of claim 1, wherein to acquire the network program media stream, the processor is further configured to:
receive a list of network services from an electronic program guide/video on demand metadata server; and
select one of the network services,
wherein the network program media stream is associated with the selected network service.

3. The subscriber device of claim 1, wherein to acquire the network program media stream, the processor is further configured to:
receive a selected network service from at least one of the plurality of display devices,
wherein the network program media stream is associated with the selected network service.

4. The subscriber device of claim 1, wherein the processor is further configured to:
receive control commands from at least one of the plurality of display devices during the delivery of the network program media stream and the advertisement.

5. The subscriber device of claim 1, wherein each display device is at least one of a digital television, set top box, personal computer, computer display, mobile phone, smartphone, tablet computer, gaming console, and handheld device.

6. The subscriber device of claim 1, wherein the usage data includes at least one of viewing statistics, personal demographic data, psychographic data, and impression reporting data.

7. The subscriber device of claim 1, wherein to select the advertisement, the processor is further configured to:
send a request to the provider network for the advertisement; and
receive the advertisement in response to the request.

8. The subscriber device of claim 1, wherein to select the advertisement, the processor is further configured to:
retrieve the advertisement from a data storage device connected to the subscriber device.

9. A method for providing Advertisement Decision Management (ADM) services from a subscriber device to a subscriber network that connects a plurality of display devices, comprising:
acquiring a network program media stream associated with a network service from a provider network;
delivering the network program media stream to said plurality of display devices;
collecting usage data for said plurality of display devices;
detecting an advertising opportunity in the network program media stream, the advertising opportunity having a start time and an end time;
selecting an advertisement to fulfill the advertising opportunity, where the selection of the advertisement is performed by the subscriber device based on the usage data;
delivering the advertisement to said plurality of display devices at the start time of the advertising opportunity; and
delivering the network program media stream to said plurality of display devices at the end time of the advertising opportunity.

10. The method of claim 9, wherein the acquiring of the network program media stream further comprises:
receiving a list of network services from an electronic program guide/video on demand metadata server; and
selecting one of the network services,
wherein the network program media stream is associated with the selected network service.

11. The method of claim 9, wherein the acquiring of the network program media stream further comprises:
receiving a selected network service from at least one of the plurality of display devices,
wherein the network program media stream is associated with the selected network service.

12. The method of claim 9, further comprising:
receiving control commands from at least one of the plurality of display devices during the delivery of the network program media stream and the advertisement.

13. The method of claim 9, wherein each display device is at least one of a digital television, set top box, personal computer, computer display, mobile phone, smartphone, tablet computer, gaming console, and handheld device.

14. The method of claim 9, wherein the usage data includes at least one of viewing statistics, personal demographic data, psychographic data, and impression reporting data.

15. The method of claim 9, wherein the selecting of the advertisement further comprises:
sending a request to the provider network for the advertisement; and
receiving the advertisement in response to the request.

16. The method of claim 9, wherein the selecting of the advertisement further comprises:
retrieving the advertisement from a data storage device connected to the subscriber device.

17. A computing device, comprising:
a communication interface to connect the computing device to a subscriber network;
a memory device resident in the computing device; and
a processor disposed in communication with the communication interface and the memory device, the processor configured to:
receive a list of network services for a provider network;
select one of the network services;
send the selected network service to a subscriber device that connects to the subscriber network, and that provides Advertisement Decision Management (ADM) services for the subscriber network; and
receive a network program media stream associated with the selected network service from the subscriber device,
wherein the subscriber device acquires the network program media stream, collects usage data for the computing device, detects an advertising opportunity in the network program media stream, the advertising opportunity having a start time and an end time, selects an advertisement to fulfill the advertising opportunity, where the selection of the advertisement is based on the usage data, delivers the advertisement to the computing device at the start time of the advertising opportunity, and delivers the network program media stream to the computing device at the end time of the advertising opportunity.

18. A method in a computing device, comprising:
receiving a list of network services for a provider network;
selecting one of the network services;
sending the selected network service to a subscriber device that connects to the subscriber network, and that provides Advertisement Decision Management (ADM) services for the subscriber network; and
receiving a network program media stream associated with the selected network service from the subscriber device,
wherein the subscriber device acquires the network program media stream, collects usage data for the computing device, detects an advertising opportunity in the network program media stream, the advertising opportunity having a start time and an end time, selects an advertisement to fulfill the advertising opportunity, where the selection of the advertisement is based on the usage data, delivers the advertisement to the computing device at the start time of the advertising opportunity, and delivers the network program media stream to the computing device at the end time of the advertising opportunity.

19. An advertisement distribution system, comprising:
a provider network for connecting and providing access to:
an electronic programming guide (EPG)/video on demand (VOD) server to provide a listing of network services from a provider; and
an advertisement server to provide advertisements for each network program media stream;
a subscriber network for connecting and providing access to:
a plurality of display devices; and
a subscriber device that provides Advertisement Decision Management (ADM) services to the subscriber network and is configured to:
acquire a network program media stream that is associated with a selected network service from the listing of network services from the provider;
deliver the network program media stream to said plurality of display devices;
collect usage data for said plurality of display devices;
detect an advertising opportunity in the network program media stream, the advertising opportunity having a start time and an end time;
select an advertisement to fulfill the advertising opportunity, where the selection of the advertisement is based on the usage data;
deliver the advertisement to said plurality of display devices at the start time of the advertising opportunity; and
deliver the network program media stream to said plurality of display devices at the end time of the advertising opportunity.

20. The advertisement distribution system of claim 19, wherein to acquire the network program media stream, the subscriber device is further configured to:
receive the listing of network services from the provider;
select one of the network services; and
send the selected one of the network services to at least one the plurality of display devices.

21. The advertisement distribution system of claim 19, wherein at least one of the plurality of display devices is configured to:
send control commands to the subscriber device during the delivery of the network program media stream and the advertisement.

22. The advertisement distribution system of claim 19, wherein to select the advertisement, the subscriber device is further configured to:
send a request to the advertisement server for the advertisement; and
receive the advertisement in response to the request.

23. The advertisement distribution system of claim 19, wherein to select the advertisement, the subscriber device is further configured to:
retrieve the advertisement from a data storage device connected to the subscriber device.
